(19) United States
(12) Patent Application Publication
(10) Pub. No.: US 2025/0073902 A1
(43) Pub. Date: Mar. 6, 2025

(54) TRAJECTORY PATH PLANNING AND MANAGEMENT OF ROBOT ARM MOVEMENTS

(71) Applicant: Emage Vision Pte, Ltd., singapore (SG)

(72) Inventors: Soon Wei WONG, singapore (SG); Lew Siang Charles CHER, singapore (SG); Kundapura Parameshwara SRINIVAS, singapore (SG)

(21) Appl. No.: 18/240,901

(22) Filed: Aug. 31, 2023

(51) Int. Cl. B25J 9/16

(52) U.S. Cl. CPC B25J 9/1664

(57) ABSTRACT

The present invention relates to a trajectory generating method for moving a Robot Arm in the fastest and smoothest path by avoiding obstructions and jerky movements in the shortest possible time to predetermined endpoints, by implementing a planning, sequence and trajectory path manager to plan the movements ahead of time and concurrently creating a database of trajectory paths that is subsequently used for storing and retrieving of repetitive movements of the Robot arm, resulting in time saving and smooth movements. In a dynamically changing operating environment, endpoints are calculated through the implementation of an intelligence module that captures a three-dimensional image of the processing area and predicts a 3D pose, which in turn is translated to positional coordinates for the Robot to utilise, to move to the target endpoint. The planning manager working in sync with the intelligence module and sequence manager enables a very favourable environment to seamlessly and efficiently move objects smoothly at controlled speeds, mimicking human movement.

### FIELD OF THE INVENTION

The present invention relates to a trajectory generating and storage method for a smooth and shortest path movement of a robot arm using a planning, sequence & Trajectory path manager in conjunction with an intelligent module. The present invention also provides for parallel processing of trajectory paths of future Robot arm movements to minimise the operating time, resulting in increased speed of the manufacturing process.

### BACKGROUND OF THE INVENTION

In an industrial setting, a trajectory is taught-in by a human expert and later played back in a typical teach-and-playback manufacturing environment. A trajectory or path connects two or more waypoints resulting in one or more trajectories per Robot arm. Each waypoint is normally taught by a human operator based on the object pick and placement postures or positions.

According to a conventional method, an operator prepares a Robot arm by teaching the waypoints, satisfying such conditions that the robot arm does not enter the area where it becomes inoperable or does not interfere with the peripheral devices or other waypoints, in a trial and error manner. In certain situations, there is a probability where a robot trajectory path that enables the robot arm to operate at optimum motion speed is not generated quickly enough, thus delaying the cycle time. In such a case, manual intervention is required to reconsider and to reset the teaching waypoints of the robot arm to achieve an optimum cycle time.

In another conventional method, an operator may prepare the Robot arm by teaching two or more waypoints which may require sharp turns or directional changes that may result in the arm generating trajectories with sudden acceleration or deceleration moves that may affect the object pickup or placement operations due to the vibrations created by such movements of the Robot arm. The chances of affecting the manufacturing environment is high, resulting in an inefficient operation, and increase in cycle time and low quality end-product.

Playback Robot arms are normally designed such that a Robot controller teaches a robot arm a plurality of waypoints, of one end of a robot arm (manipulator); these waypoints may include (but not limited to) a starting point, an endpoint, and intermediate points there between. To the one end of the manipulator, a Robot hand is suitably integrated. The robot controller is programmed to execute interpolation on the taught command points to determine a trajectory passing through the waypoints. Next, the robot controller is programmed to smoothly move the robot arm along the determined trajectory. While this can work in most environments, the Robot arm is likely to encounter collisions with certain obstructions or a dynamically changing environment where the waypoints can move according to the task at hand and the object to be processed.

Trajectory path generation aims at creating movement control paths of Robot arms, which ensure that the planned trajectory is smoothly executed without any destabilising jerky movements and covers the distance in the fastest possible time without colliding with any of the waypoints around the area of operation.

Advanced trajectory path generation along with a planning manager is required to implement a forward-looking strategy to perform a movement of a particular trajectory path without adding to the timing overhead and one that may comprise trajectory paths that have been planned well in advance to speed up the Robot arm. Managing a Robot arm trajectory taking into account obstacle avoidance, traversing a complicated maze and in some complex cases, with dynamically changing waypoints, by implementing an intelligence module, ensures for a more efficient, safe and fast operation. During the managing and advanced planning of trajectories there are many mechanical motion laws which have to be considered, such as velocity and acceleration saturation limits of the motor drives, resonant points of the actuator structure, when using electric/hydraulic or pneumatic driving modes to arrive at a smooth trajectory path in practical implementations. A trajectory path involves the determination of a path using multiple waypoints, through which the routing is planned to avoid collision and determine the shortest route. The path is subsequently used by the Robot controller to move the Robot arm in the planned trajectory path. The trajectory path uses the geometric path planned for a particular task, to determine the velocity and acceleration around each waypoint depending upon the angle of traverse, to minimise effects of resonance and smoothen the movement of the Robot arm. In a simple industrial machine, a trajectory path is usually trained by a human operator through trial and error. However, as machines get more complex and increase their level of capability in performance, it is necessary that automatic methods of trajectory path planning are incorporated wherein a trajectory path planning manager alone may not suffice. In such cases an imaging based apparatus and method in conjunction with an intelligence module is required to dynamically plan the trajectory paths by using forward looking algorithms and pre-stored trajectory paths or in cases whether the Robot environment has changed, it is essential that the new trajectory path is quickly calculated and communicated to the Robot controller to ensure speedy performance. Furthermore, by incorporating Artificial intelligence and machine learning techniques, all frequently used trajectory paths are stored in databases relevant to a specific product type so as to minimise machine configuration setup during product changeovers. These methods have therefore become a necessity rather than an option in Robot controlled industrial settings.

In certain cases, trajectory path planning algorithms have limitations that may sometimes result in failure to plan the Robot arm movement from one waypoint to another in one trajectory, by avoiding obstacles. In such cases, it is essential to plan multiple trajectories while handling an object, when the Robot arm is required to manoeuvre around the obstruction carefully in which case, two or more intermediate points may need to be added between two waypoints and thereby planning and combining multiple trajectories to reach target position. This results in start/stop movements characteristic of a robotic motion executing multiple trajectories, with multiple deceleration and acceleration movements for each trajectory, causing vibrations due to resonance characteristics involved.

### SUMMARY OF THE INVENTION

In view of the background, an object of an aspect of the present invention is to provide a Trajectory path-planning manager to the motion control apparatus using a Planning manager in conjunction with a Sequence manager for standard practical applications where the waypoints do not change.

Another object of an aspect of the present invention is to provide a trajectory path planning manager to the motion control apparatus, for a dynamically changing environment wherein the waypoints can change, by complimenting the Planning and sequence manager with an intelligence module to capture an image and provide a mapping to the Trajectory path-managing module. The intelligence module aids in handling complex situations usually occurring in multiple Robot arm applications or obstructions. Using the working layout map provided by the intelligence module, the trajectory path-managing module generates the desired path waypoints utilising a class of polynomial interpolation or spline interpolation, to arrive at a time-based control sequence to move the Robot arm from its current position to the destination smoothly. The trajectory path-manager module deals with an exponential complexity with respect to the degrees of freedom (controllable joints) of a given Robot by applying Artificial intelligence followed by Machine learning techniques. The trajectory path manager further includes means for computing from the spline interpolation implementation that produce a smooth motion between multiple path segments without position, velocity and acceleration discontinuities and avoiding the Runge's phenomenon which causes oscillation or ringing at the beginning or end of the Robot arm motion which is typical in Polynomial Interpolation implementations when working with equidistant waypoints.

According to a further aspect of the present invention, there is provided a method of determining a single motion by implementing a chain-movement mode wherein multiple trajectories are planned together and then clubbed as one. This will reduce pauses between two trajectories, as the Robot arm does not have to wait for the next trajectory to be planned for each segment of the multi-part path. While merging multiple trajectories, it is normal to experience some slowdown during multiple trajectory transitions due to deceleration and acceleration at each intermediate waypoint, especially if the planned trajectories require an abrupt change in direction. To overcome this issue, a blending concept is implemented for the trajectories, with a smooth curve wherein the intermediate waypoint is not reached but rather a blending radius is calculated to merge with the path of the next trajectory to effectively reduce or minimise the sudden deceleration and acceleration effect. The blending is controlled by a blend radius parameter that decides the amount of curvature needed to smoothen the path near the transition. This renders the motion to be as smooth as a human movement.

According to a further aspect of the present invention, there is provided a method, wherein trajectories between all known waypoints are planned ahead of time by the planning manager so, when a trajectory sequence needs to be executed, the Robot controller fetches the trajectory from the planning manager without any wait time, as the trajectories are pre-planned and pre-stored. In the event, pre-planned and stored trajectory paths are unavailable for a set of waypoints, the planning manager along with the sequence manager determines the trajectory path from the beginning state to the nearest intermediate point where pre planned trajectory paths exists, resulting in significant reduction in time compared to instances where pre planned trajectory paths are not available. The same logic is executed in the event pre-stored trajectory paths do not exist to the final state, in which case, a new trajectory path is determined from the nearest waypoint to the final state. The flexibility of the pre-stored trajectory paths database is enhanced making it more efficient and speedy.

According to a further aspect of the present invention, there is provided a method, wherein a 3D (Three dimensional) image of the working environment is captured by the intelligence module which predicts a 3D pose or map, to determine the coordinates of all waypoints and obstructions to guide the Robot arm to a particular endpoint depending upon the instruction received from the Robot controller. Furthermore, parameters such as rotational coordinates for row pitch and yaw are additionally determined depending upon the 3D map, resulting in 6D (Six dimensional) calculation of the trajectory path to move the Robot arm from the start to the final state.

According to a further aspect of the present invention, there is provided a method, wherein the intelligence manager handles a pipeline of imaging server actions to determine object locations and communicate the non-linear trajectory sequence to the Robot controller in real time.

According to a further aspect of the present invention, there is provided a method for rapidly computing motion trajectories for automated systems such as robots, cranes, and vehicles. Given a set of waypoints and the associated obstacles and constraints, one or more begin state of the Robot, and one or more desired end states for the Robot, the method starts with a novel iterative procedure to compute a sample motion trajectories that are fast and meets the objective of the target state of the Robot. Each iteration improves the trajectory, by implementing PID (Proportional-integral-derivative), MFC (Model predictive control) and Adaptive control algorithms to make the movement of the Robot Arm faster and smoother, until it satisfies all criteria to desired tolerances of acceleration and velocity with respect to the payload. Offline (prior to execution), this procedure is used to generate multiple trajectories under several begin states and end states of the Robot and subsequently applying Artificial intelligence & Machine learning techniques to create a database of all frequently used trajectories. The process enables rapid responses to commands for moving the Robot from one state to another, as the database has most trajectories pre-calculated and stored ahead of time. With further implementation of Deep learning techniques, the Robot processes and movement are stored and optionally fine-tuned through frequent computation involving varying input and output states of the Robot.

With planning and sequence managers working together with the Intelligence module, most of the trajectories are ready to be executed, with minimum computational time. This process of handling a visually guided Robot arm with complex equilibrium paths is fast, seamless and smooth, mimicking a human movement.

### BRIEF DESCRIPTION OF DRAWINGS

The present disclosure will be better understood from reading the following description of non-limiting embodiments, with reference to the attached drawings:

FIG. 1 shows a block diagram of a computing system comprising the various subsystems involved that determines an optimised trajectory path, to command the Robot controller for the respective Robot arm motion.

FIG. 2 shows a flow diagram illustrating a trajectory motion planning for a Robot arm with predetermined waypoints, according to an embodiment.

FIG. 3 shows a flow diagram illustrating a trajectory motion planning of a Robot arm with predetermined and dynamic waypoints, according to an embodiment.

FIG. 4 shows a flow chart of the sequence A wherein the intelligence manager predicts the 3D waypoints, calculates the rotational coordinates Roll, Pitch and Yaw, resulting in a six dimensional trajectory path of the working area according to an embodiment.

FIG. 5 shows an example of a trajectory path between six waypoints using spline interpolation.

### DETAILED DESCRIPTION OF DRAWINGS

The following description relates to computing motion trajectory paths for automated systems, that takes into account the payload and the equilibrium of the Robot while avoiding obstructions, reducing stresses to minimise wear and tear of the mechanics involved, to produce a swift and jerk free motion from an initial position to a final position.

In one embodiment of the present disclosure, the system and methods provided herein is used to speed up and improve the motion of a robot for loading and unloading contact lens blister packs from an input loader to the inspection location in an automated line. In this case the set of begin states are defined by a desired position of a suction cup or pickup end effector integrated to the robot to lift the Blister pack. The set of end states is defined by a position of the pickup end effector at the inspection station wherein accurate fine positioning occurs through intelligent imaging and subsequent deactivation of the end effector suction cup holding the contact lens blister pack resulting in unloading at the inspection station. There is a high degree of positional accuracy in the X, Y and Z axis and orientation at the end state of unloading the contact lens blister pack. To increase system throughput and reduce wear on the robot, it is desirable to rapidly compute a motion trajectory path from one of the begin states to one of the end states that avoids both fixed and dynamically moving obstacles using a Chain-mode concept. The Chain-mode is implemented by the planning manager by concatenating multiple trajectories by adopting smooth movements in velocity and acceleration to ensure a vibration and jerk free motion through all the given waypoints.

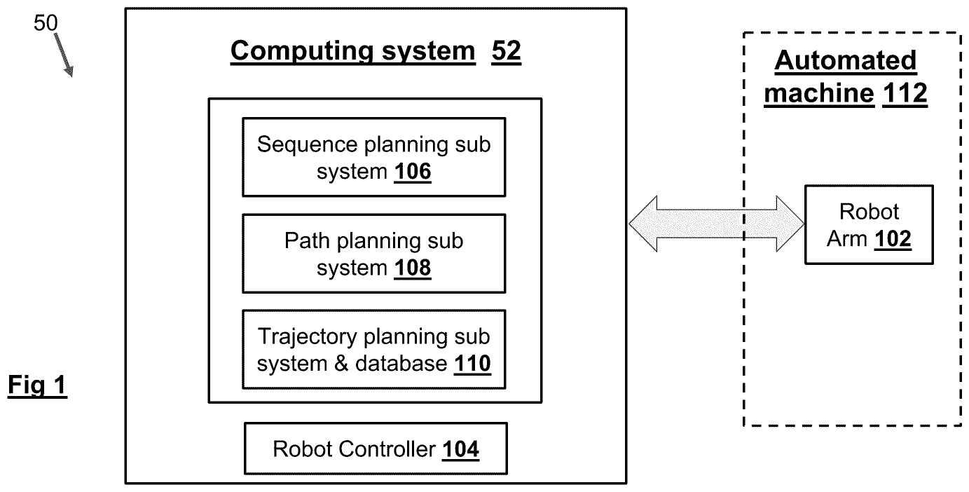

Referring to FIG. 1, the block diagram 50 is illustrated as an example of a computing system 52 for a jerk free and vibration free motion planning, according to an embodiment. The computing system 52 comprises a sequence planning sub-system 106, path-planning sub-system 108 and a trajectory planning sub-system 110 suitably linked to a database and communicatively coupled to an Robot controller 104 to control a robot arm 102 or another system adapted for autonomous motion, within the automated machine 112. Although the computing system 52 is depicted as a separate system from the Robot controller 104, it should be appreciated that in some examples, one or more components of the computing system 52 may be integrated into the Robot controller 104 or as a standalone module, to operate the Robot arm 102. The computing components may include but are not limited to Artificial Intelligence, Machine learning, Reinforced learning and Deep learning algorithms to build a powerful and efficient database of trajectory paths that are readily available, instead of calculating the trajectory paths in real time, when a waypoints map is received from the computing system. The database serves as a readily usable trajectory paths storage sub-system, adaptable to different configurations of industrial machines used in processing and manufacturing different products.

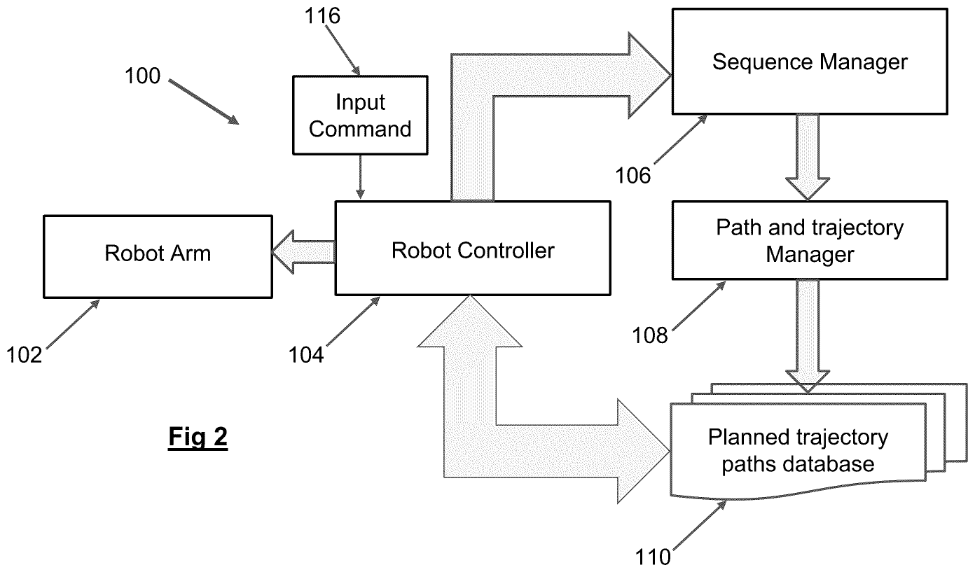

Referring to FIG. 2, the flowchart 100 schematically illustrates operations to be executed by the Robot controller. The flow diagram 100 shows the interaction between the various modules within the computing system 52 of FIG. 1. The flow diagram is especially focussed on automated machines, wherein the trajectory paths that are planned are based on a predetermined set of waypoints. This is adaptable to automated machines such as packaging, sorting or labelling of processed products wherein most of the processing points for the products are fixed.

The flow typically begins with the input command 116 to the Robot controller. Subsequently the Robot controller communicates the waypoints (Initial waypoint and Final waypoint) to the planned trajectory paths database 110. The database in return transmits the desired trajectory path to the Robot controller if the pre-planned or predetermined path is available for the said waypoints, following which the Robot controller 104 will drive the Robot Arm 102 to final destination waypoint at the specified motion speed, velocity and the trajectory path. However, in the event a predetermined trajectory path is absent or unavailable, the Robot controller 104 gets information from the Planned trajectory paths database 110 about the non-existence of a predetermined trajectory path, which is then followed up with a command to the sequence manager 106 by the Robot controller 104, to begin the process of planning a new trajectory path. The sequence manager 106 further checks the waypoint positions and decides on the sequence of trajectory paths to execute after implementing blending of trajectory paths with all intermediate waypoints, taking into account the blend radius parameter, that decides the amount of curvature necessary to smoothen the trajectory path near the transition from one waypoint to next. Subsequently, the calculated sequence is communicated to the path manager 108 that determines the fastest trajectory path to the final destination waypoint and uploads the information to the planned trajectory path database 110 for storage and further communication to the Robot controller 104, which in turn executes the motion of the Robot Arm 102. The executed motion results in a motion that is as smooth as a human movement.

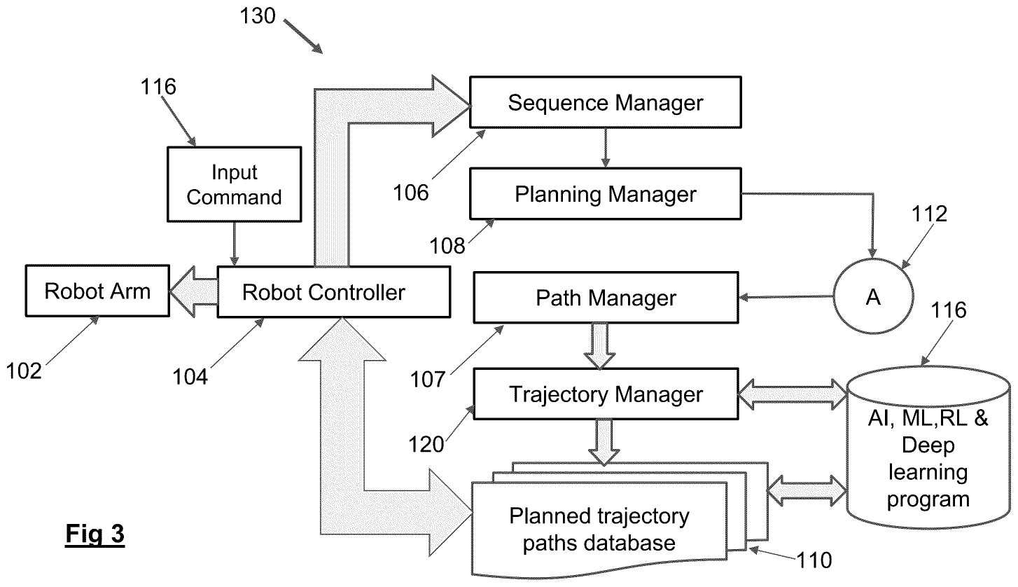

In FIG. 3, the flowchart 130 schematically illustrates operations to be executed by the Robot controller where dynamic waypoints are encountered. The flow diagram 130 shows the interaction between the various modules within the computing system 52 of FIG. 1, wherein the planned trajectory paths are based on both varying and fixed set of waypoints. This is adaptable to automated machines where interaction between several processing points are involved resulting in unpredictable environments and changing conditions. The complexity of such operations requires a series of pre-planned sequence of movements, on-the-fly calculations of trajectories, and the path manager capable of quickly rearranging the sequences and trajectory paths to achieve smooth and precise operation of the Robot Arm.

The flow chart in FIG. 3 starts with the input command 116, to the Robot controller. Subsequently the Robot controller 104 communicates the waypoints (initial, intermediate and final waypoints) to the planned trajectory paths database 110. The database in return transmits the desired trajectory path to the Robot controller if the pre-planned or predetermined trajectory path is available for the said waypoints, following which the Robot controller 104 will drive the Robot Arm 102 to final destination waypoint at the specified motion speed, velocity and curvature. However, in the event a predetermined trajectory path is absent or unavailable or if there are obstructions to the pre-planned trajectory paths, the Robot controller 104 sends a command to the sequence manager 106 to begin the process of planning the new trajectory. The sequence manager 106 further checks the waypoint positions that include obstructions and intermediate waypoints. The information is conveyed to the planning manager 108. The planning manager realising the new changed environment, sends a query to branch 112 (A). The trajectory path manager determines the trajectory path by implementing PID (Proportional-integral-derivative), MFC (Model predictive control) and Adaptive control algorithms to ensure a jerk free and resonant free movement from an begin state or waypoint to a end state or waypoint of the Robot Arm, through all the intermediate waypoints. Furthermore, the calculated trajectory path is uploaded to 116 for further characterisation of the trajectory path using Artificial intelligence, Machine learning and Reinforced learning and subsequently updated to the database 110 residing in the computing system 52 of FIG. 1 or in the cloud. The database 110 is iteratively fine-tuned and updated to ensure the Robot Arm can be operated by utilising the pre-planned trajectory paths, with minimal delays for a specific command.

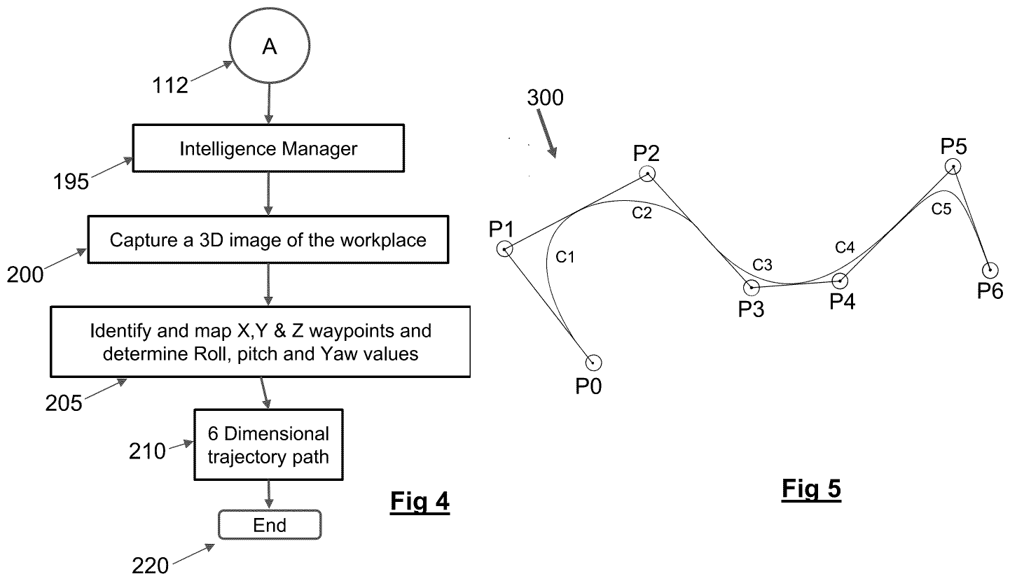

In FIG. 4, the flow chart A begins with the intelligence manager 195 sending commands to the imaging system to capture a 3D pose of the working environment at step 200. In step 205 the software algorithm identifies and calculates the X, Y & Z coordinates and determines the rotational values related to roll, pitch and Yaw and subsequently returns a total of six values namely, the X, Y & Z coordinates of the current state of waypoint locations that may include obstructions and intermediate waypoint locations along with the determined values for roll, pitch and yaw, at step 210. In step 210 a trajectory path. Furthermore, parameters such as rotational coordinates such as Pitch, Roll and Yaw are determined taking into account all the waypoints, start state and final state in 205 to determine the trajectory path in 210. In the next step, the six dimensional trajectory path determined in 210 is relayed to the path manager 107 in FIG. 3 and subsequently ends the flow in 220.

In FIG. 5, an example of a trajectory path calculated using spline interpolation between six waypoints P0-P6 is illustrated. Spline interpolation fits low-degree polynomials between two neighbouring waypoints, for example, fitting five cubic or piecewise polynomials between each of the pairs of six waypoints, instead of fitting a single degree-six polynomial. This minimises interpolation error and also eliminates problems associated with oscillation (Vibration) resulting in a smooth movement of the Robot Arm. In the diagram 300 of FIG. 5, six waypoints namely P0, P1, P2, P3 . . . P6 are shown as an example. C1-C5 are the resulting curves blended to form a spline curve between each pair of waypoints. As evident, the Robot controller follows the trajectory path of C1 to C5 to move from its begin state P0 to the end state P6. The mathematical formulas or analysis, acceleration, deceleration and peak velocity between waypoints are not discussed as they fall outside the scope of the invention.

It will be understood that various modifications that are not described yet may be made therein, and it is intended to cover in the appended claims all such modifications as fall within the scope of the invention. The written description uses typical cases to disclose the invention, and also to enable a person of ordinary skill in the relevant art to practise the invention, including making and using any devices or systems and implementing any incorporated methods. The patentable scope of the invention is defined by the claims, and may include other instances that may occur to those of ordinary skill in the art.

1. A method, comprising:
computing a trajectory, with a Planning, Sequence and trajectory manager, in combination with an intelligence module that utilises an imaging system, using spline interpolation and fitting multiple low-degree polynomials between two neighbouring waypoints from a begin state to an end state through one or more intermediate way points;
updating the trajectory to a database in the computing system or on the cloud, for quick retrieval of trajectory paths and fast processing of objects in a Robot arm driven environment, according to kinematic limits and dynamic limits of the automated system to obtain a final trajectory; and
operating the Robot arm from a begin state through one or more intermediate waypoints to an end state according to the final trajectory as communicated by the Robot controller.

2. The method of claim 1, wherein computing the trajectory comprises computing, with the PID (Proportional-integral-derivative), MFC (Model predictive control), and Adaptive control algorithms, a plurality of trajectories for an input command specifying the one or more begin states of the Robot Arm and the one or more end states of the Robot Arm, each trajectory path of the plurality of trajectories with a different duration and different distances.

3. The method of claim 2, wherein the Planning and sequence manager computes the plurality of trajectories according to the degrees of freedom related to the Robot arm in the one or more begin states and the one or more end states.

4. The method of claim 2, wherein the Planning and sequence manager computes the plurality of trajectories in conjunction with the intelligence module according to the degrees of freedom related to the Robot arm in the one or more begin states and the one or more end states.

5. The method of claim 2, further comprising updating the trajectory path to minimise jerking in the Robot arm by repeated fine tuning through application of Artificial intelligence and Machine learning combined with Reinforced learning techniques to achieve optimum speed and accuracy over time.

6. The method of claim 2, further comprising updating the trajectory paths according to respective input states and end states to a database for storage and retrieval.

7. The method of claim 1, wherein the working environment comprises a robotic arm mounted on an industrial machine configured for repetitive and non-repetitive motion.

8. The method of claim 7, wherein a repetitive motion trajectory path is acquired from the pre-stored trajectory paths residing in the database in the computing system or the cloud.

9. The method of claim 7, wherein a non-repetitive motion trajectory path is calculated by utilising the 3D positions of all waypoints of the working environment acquired by the imaging system and determining the Roll, pitch and yaw required for the Robot arm to move from a begin state to the end state.

10. The method of claim 7, wherein if a non-repetitive motion trajectory path is non-existent in the database from a given begin state to an end state, the computing system primarily identifies the nearest waypoint to the begin state and the nearest waypoint to the end state and subsequently acquires a trajectory path between these two repetitive waypoints which may be pre stored in the database.

11. The method of claim 10, wherein the computing system calculates the trajectory path to the nearest way point from the begin state followed by another trajectory path from the nearest waypoint to the end state to arrive at a full trajectory path from a begin state to the end state, effectively combining a predetermined trajectory path acquired from the database and a set of calculated trajectory paths.

12. A system, comprising:
an automated machine utilising a Robot and operated by a Robot controller system configured for automatic, repetitive and non-repetitive motion;
the Robot controller configured with software applications that when executed cause the controller to:
compute, with PID (Proportional-integral-derivative), MFC (Model predictive control) and Adaptive control algorithms, trajectory paths from one or more begin states of the working environment to one or more end states;
update, the trajectory path with relevant constraints and limitations to a database residing on the computing system or on a cloud for subsequent storage and retrieval;
and;
automatically control the automated machine from an begin state of the one or more beginning states to an end state of the one or more end states according to the trajectory path.

13. The system of claim 8, wherein, to compute the trajectory, the controller is further configured with algorithms that cause the controller to:
compute a plurality of trajectory paths for an input specifying the one or more begin states of the automated machine and the one or more end states of the automated machine, each trajectory path of the plurality of trajectory path with a different duration, velocity, acceleration and curvature.

14. A system, comprising:
an automated machine utilising a Robot and operated by a Robot controller system incorporating an imaging system and configured for automatic, repetitive and non-repetitive motion;
the Robot controller configured with software applications that when executed cause the controller to:
acquire, images of the working environment using the imaging system and identify the waypoints;
compute trajectory paths using the intelligence module, and applying PID (Proportional-integral-derivative), MFC (Model predictive control) and Adaptive control algorithms, from one or more begin states of the working environment to one or more end states navigating through the intermediate waypoints;
update, the trajectory path with relevant constraints and limitations to the database residing on the computing system or on a cloud for subsequent storage and retrieval;
and;
automatically control the automated machine from an begin state of the one or more beginning states to an end state of the one or more end states according to the trajectory path.
